(19) United States
(12) Patent Application Publication
(10) Pub. No.: US 2020/0175415 A1
(43) Pub. Date: Jun. 4, 2020

(54) SYSTEM AND METHOD FOR CUSTOMIZING INFORMATION FEED

(71) Applicant: DiDi Research America, LLC, Mountain View, CA (US)

(72) Inventor: Yayi ZOU, Palo Alto, CA (US)

(21) Appl. No.: 16/204,804

(22) Filed: Nov. 29, 2018

(51) Int. Cl. G06N 20/00; G06N 7/00; G06Q 30/02; G06Q 10/06

(52) U.S. Cl. CPC G06N 20/00; G06N 7/005; G06Q 10/067; G06Q 30/0242; G06Q 30/0201; G06Q 30/0211

(57) ABSTRACT

A computer-implemented method for customizing information feed comprises: training a Bayesian Two Stage (BTS) model with historical data [Xₜ,Zₐ,Y] from a pool of historical users and historical activities to obtain a trained BTS model; obtaining an activity rendering request from a computing device associated with a current user; obtaining the user response prediction for each of a pool of current candidate activities based on the trained BTS model, current user feature data of the current user, and current activity feature data of the candidate activities to determine a predicted activity from the candidate activities; and causing the computing device to render the predicted activity.

### TECHNICAL FIELD

This disclosure generally relates to methods and devices for customizing information feed.

### BACKGROUND

Developments in electronic technologies have allowed data feed to user devices. For example, a mobile phone application (APP) installed in mobile phones may display information fed by a server. However, it is challenging to determine the customization of the information feed that optimizes the effect on the users.

### SUMMARY

Various embodiments of the present disclosure include systems, methods, and non-transitory computer readable media for customizing information feed.

According to one aspect, a computer-implemented method for customizing information feed comprises: training a Bayesian Two Stage (BTS) model with historical data [Xₜ,Zₐ,Y] from a pool of historical users and historical activities to obtain a trained BTS model, wherein: Xₜ represents historical user feature data, Zₐ, represents historical activity feature data, Y represents historical metric data of user response, X_{a,t} represents historical user-activity feature data, and the BTS model comprises (1) a first stage model receiving [Xₜ,Zₐ] as inputs and generating at least a first posterior distribution parameter as output and (2) a second stage model receiving [Xₜ,X_{a,t}] and the first posterior distribution parameter as inputs and generating at least a user response prediction as output. The method further comprises: obtaining an activity rendering request from a computing device associated with a current user; obtaining the user response prediction for each of a pool of current candidate activities based on the trained BTS model, current user feature data of the current user, and current activity feature data of the candidate activities to determine a predicted activity from the candidate activities; and causing the computing device to render the predicted activity.

In some embodiments, the user feature comprises personal bio information, Application (APP) use history, inferred information, and online features; the personal bio information comprises at least one of: age, gender, or residence zip code; the APP use history comprises at least one of: ride hiring history, work address, residence address, or preference for coupon usage; the inferred information comprises at least one of: income level or personal preference; and the online features comprise at least one of: time when using the APP, location when using the APP, or type of mobile phone carrying the APP.

In some embodiments, the activity feature comprises a rendering position in an Application (APP) and a topic of the activity.

In some embodiments, the user-activity feature comprises a rate rendering the activity in history and a rate receiving response to the rendered activity in history.

In some embodiments, the metric data of user response comprises a click through rate (CTR).

In some embodiments, the activity is selected from a group consisting of: rendering coupon, rendering promotion, rendering reminder, rendering task, and rendering advertisement.

In some embodiments, the first stage model and the second stage model are Bayesian logistic regression models; the second stage model further generates a second posterior distribution parameter as another output; and for the training, the second stage model feeds back the second posterior distribution parameter to the first stage model to adjust the first posterior distribution.

In some embodiments, the predicted activity has the best second user response prediction with respect to the metric data of user response. In some embodiments, the predicted activity is determined based on an exploration algorithm with respect to the metric data of user response.

According to another aspect, a system for customizing information feed comprises: a processor and a non-transitory computer-readable storage medium storing instructions that, when executed by the processor, cause the system to perform: training a Bayesian Two Stage (BTS) model with historical data [Xₜ,Zₐ,Y] from a pool of historical users and historical activities to obtain a trained BTS model. Xₜ represents historical user feature data, Zₐ, represents historical activity feature data, Y represents historical metric data of user response, X_{a,t} represents historical user-activity feature data, and the BTS model comprises (1) a first stage model receiving [Xₜ,Zₐ] as inputs and generating at least a first posterior distribution parameter as output and (2) a second stage model receiving [Xₜ,X,_{a,t}] and the first posterior distribution parameter as inputs and generating at least a user response prediction as output. The system is further caused to perform: obtaining an activity rendering request from a computing device associated with a current user; obtaining the user response prediction for each of a pool of current candidate activities based on the trained BTS model, current user feature data of the current user, and current activity feature data of the candidate activities to determine a predicted activity from the candidate activities; and causing the computing device to render the predicted activity.

According to another aspect, a non-transitory computer-readable storage medium storing instructions that, when executed by a processor, cause the processor to perform: training a Bayesian Two Stage (BTS) model with historical data [Xₜ,Zₐ,Y] from a pool of historical users and historical activities to obtain a trained BTS model. Xₜ represents historical user feature data, Zₐ, represents historical activity feature data, Y represents historical metric data of user response, X_{a,t} represents historical user-activity feature data, and the BTS model comprises (1) a first stage model receiving [Xₜ,Zₐ] as inputs and generating at least a first posterior distribution parameter as output and (2) a second stage model receiving [Xₜ,X_{a,t}] and the first posterior distribution parameter as inputs and generating at least a user response prediction as output. The processor is further caused to perform: obtaining an activity rendering request from a computing device associated with a current user; obtaining the user response prediction for each of a pool of current candidate activities based on the trained BTS model, current user feature data of the current user, and current activity feature data of the candidate activities to determine a predicted activity from the candidate activities; and causing the computing device to render the predicted activity.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an exemplary system for customizing information feed, in accordance with various embodiments.

FIG. 2 illustrates an exemplary system for customizing information feed, in accordance with various embodiments.

FIG. 3 illustrates an exemplary table of model inputs and output, in accordance with various embodiments.

FIG. 4 illustrates a flowchart of an exemplary method for customizing information feed, in accordance with various embodiments.

FIG. 5 illustrates a block diagram of an exemplary computer system in which any of the embodiments described herein may be implemented.

### DETAILED DESCRIPTION

Various software programs installed on hardware devices such as computer and mobile phone may feed various information to users. For example, a mobile phone application (APP) may feed information to mobile phones installed with the APP. The APP may comprise one or more in-application booths for rendering the information feed. The information feed may be rendered as a visual display, a sound play, a video play, etc. The information feed (e.g., the activity a) may comprise, for example, coupon, promotion, reminder, task, external advertisement, etc. The effect of the information feed can be measured based on various metrics, such as the click through rate (CTR) that indicates a percentage of users that respond to the information feed. Depending on the application, the metrics may vary.

Existing technologies may feed the same information universally to all hardware devices installed with the software program. This method is ineffective because different users usually have diverse interests and respond differently to the same information feed. As a result, the universal information feed may prove to be a waste for a large percentage of uninterested users.

To at least mitigate the deficiencies in the existing technologies, systems and methods for customizing information feed are disclosed. In some embodiments, the disclosed systems and method may allow different users to receive customized information feed such as activities that are predicted to optimize metrics like CTR. Each activity (a) may be a unit, and the data associated with the each activity is the click history of users (each user being t) who received the activity. To optimize the CTR, the response for user t toward the fed activity a may be determined as the estimated click probability r_{t,a}. For example, the response r_{t,a} and its confidence interval are computed for each candidate activity a in candidate actions A. The best candidate activity may have the highest r_{t,a} or meet another condition according to an exploration algorithm. The best candidate activity may be chosen to render in the APP.

An exemplary method for determining r_{t,a} is to use a prediction model. Prediction tasks under hierarchical data may need to consider two kinds of information: the uniqueness of each unit (for example, the uniqueness extracted from data within each unit and features of each unit) and the correlations between units (for example, correlations extracted from data among units). The uniqueness may matter more when one unit has sufficient data, since the data may enable a prediction and the uniqueness may enhance the accuracy. The correlation may matter more when the one unit has sparse data, since now data from other units is needed to help supplement the sparse data and enable a prediction within the one unit. Often, the situation sits in between and the difficulty of combining both uniqueness and correlation arises. And another difficulty is how to incorporate features of various units into the frame.

In current technologies, an existing model for performing the prediction is mixed effect model. The mixed effect model assumes the model parameters of each unit to be correlated, for example, sampled from a prior distribution. Typically, the mixed effect model uses type 2 Maximum Likelihood Method to estimate the hyper parameters of the prior distribution. An expectation-maximization (EM) algorithm can be applied to this type 2 Maximum Likelihood Method. This model may capture the correlations and uniqueness from the data among units but fail to incorporate the information from features of each unit, falling short of achieving the optimized estimation. Another existing model is global supervised learning model which is trained by data of all units and features of units. However, this model cannot capture the uniqueness of each unit. Yet another existing model is supervised learning model which is trained by data within each unit. However, this model does not account for correlations among units.

In various embodiments, a Bayesian Two Stage (BTS) model that at least mitigates the deficiencies of the current technologies is disclosed to perform the prediction. The disclosed model achieves a better generalization by incorporate features of units, a better utilization of uniqueness of each unit, and a better utilization of correlations among units. Though this disclosure uses information feed as an example in which the unit corresponds to an activity, the disclosed systems and methods (e.g., the prediction model) may be applied to various other occasions where hierarchical data can be divided into units. The applications may include, for example, patient treatment results by doctors, transportation passengers' price elasticity from within geographic zones, etc.

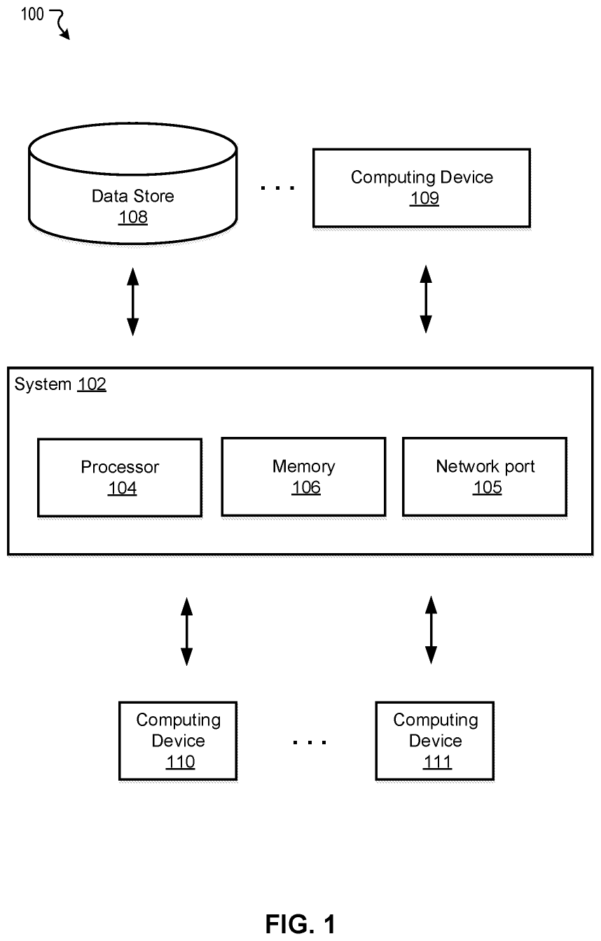

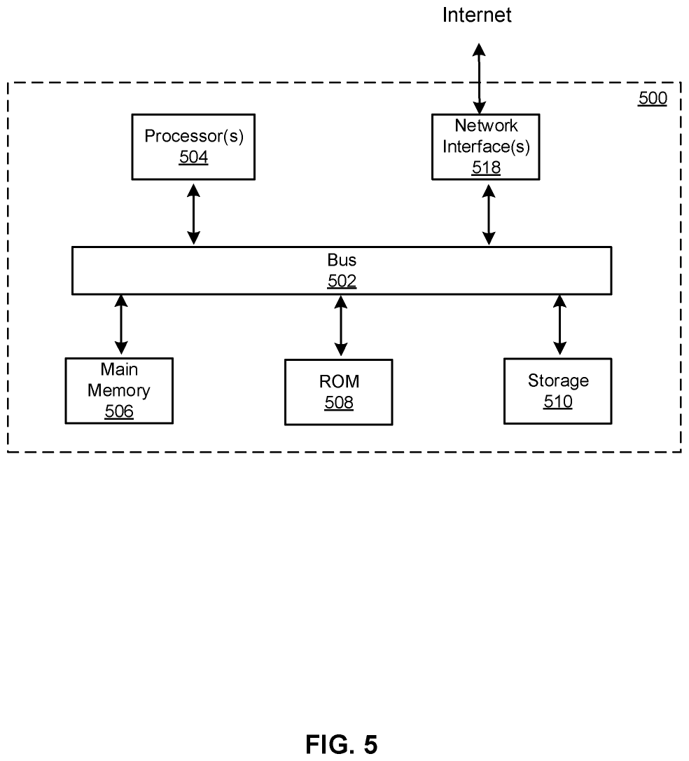

FIG. 1 illustrates an exemplary system 100 for customizing information feed, in accordance with various embodiments. As shown in FIG. 1, the exemplary system 100 may comprise at least one computing system 102. The system 102 may be implemented on or as various devices such as mobile phone, tablet, server, computer, wearable device (smart watch), etc. The system 102 may be installed with appropriate software (e.g., platform program, etc.) and/or hardware (e.g., wires, wireless connections, etc.) to access other devices of the system 100. The computing system 102 may include one or more processors 104, one or more memories 106, and one or more network ports 105. The memory 106 may be non-transitory and computer-readable. The memories 106 may store instructions that, when executed by the one or more processors 104, cause the one or more processors 104 to perform various operations described herein. The one or more processors 104 and/or the one or more memories 106 may be implemented as one or more circuits described below with reference to FIG. 5.

The system 100 may include one or more data stores (e.g., a data store 108) and one or more computing devices (e.g., a computing device 109) that are accessible to the system 102. In some embodiments, the system 102 may be configured to obtain data (e.g., click history of in-application booths) from the data store 108 (e.g., a database or dataset of user history) and/or the computing device 109 (e.g., a computer, a server, a mobile phone used by a user). The system 102 may use the obtained data to train the model for optimizing information feed.

The system 100 may further include one or more computing devices (e.g., computing devices 110 and 111) coupled to the system 102. The computing devices 110 and 111 may comprise devices such as cellphone, tablet, computer, wearable device (smart watch), in-vehicle computer, etc. The computing devices 110 and 111 may transmit or receive data to or from the system 102. Thus, in various embodiments, the system 102 may comprise one or more network ports to communicate with user terminals (e.g., computing devices 110 and 111) registered with an online transportation service platform, and one or more circuits coupled to the one or more network ports. During operation the circuits may perform various methods and steps described herein.

In some embodiments, the system 102 may implement an online information or service platform. The service may be associated with vehicles such as cars, bikes, boats, and airplanes, and the platform may be referred to as a vehicle (service hailing or ride order dispatching) platform. The platform may accept requests for transportation, identify vehicles to fulfill the requests, arrange for pick-ups, and process transactions. For example, a user may use the computing device 110 (e.g., a mobile phone installed with a software application associated with the platform) to request transportation from the platform. The system 102 may receive the request and relay it to various vehicle drivers, for example, by posting the request to mobile phones carried by the drivers. A vehicle driver may use the computing device 111 (e.g., another mobile phone installed with the application associated with the platform) to accept the posted transportation request and obtain pick-up location information. Fees such as transportation fees can be transacted among the system 102 and the computing devices 110 and 111.

In some embodiments, on user-end devices, platform may be implemented as an installed APP. The APP may comprise various in-application booth for rendering information such as coupon, promotion, reminder, task, external advertisement, etc. The rendered information may be related to the vehicle service. The APP may also monitor user history of the APP such as the CTR with respect to each booth. Certain monitored data may be stored in the memory 106 or retrievable from the data store 108 and/or the computing devices 109, 110, and 111.

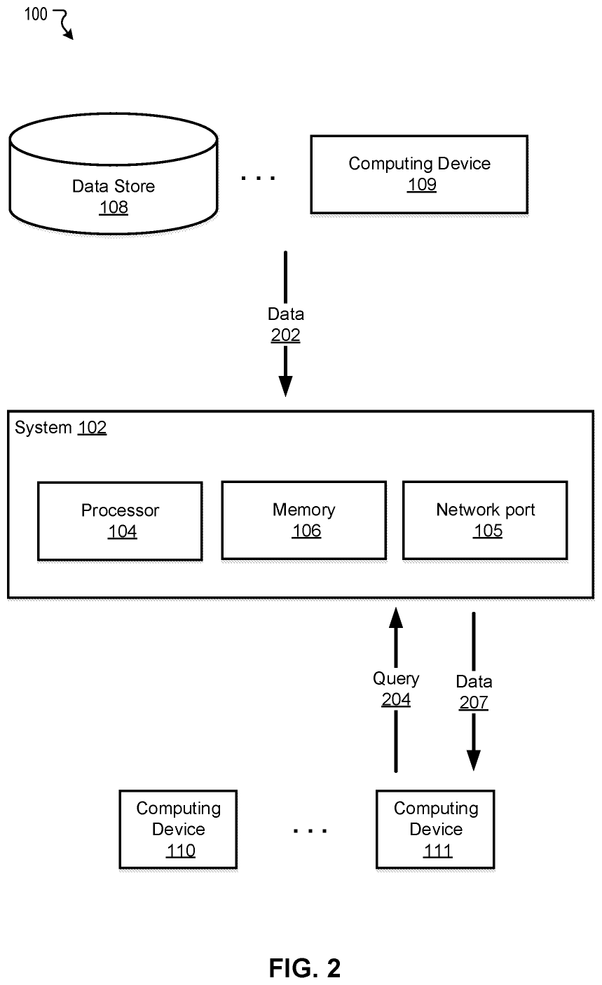

In some embodiments, the system 102 and the one or more of the computing devices (e.g., the computing device 109) may be integrated in a single device or system. Alternatively, the system 102 and the one or more computing devices may operate as separate devices. The data store(s) may be anywhere accessible to the system 102, for example, in the memory 106, in the computing device 109, in another device (e.g., network storage device) coupled to the system 102, or another storage location (e.g., cloud-based storage system, network file system, etc.), etc. Although the system 102 and the computing device 109 are shown as single components in this figure, it is appreciated that the system 102 and the computing device 109 can be implemented as single devices or multiple devices coupled together. The system 102 may be implemented as a single system or multiple systems coupled to each other. In general, the system 102, the computing device 109, the data store 108, and the computing device 110 and 111 may be able to communicate with one another through one or more wired or wireless networks (e.g., the Internet) through which data can be communicated. Various aspects of the system 100 are described below in reference to FIG. 2 to FIG. 5.

FIG. 2 illustrates an exemplary system 100 for customizing information feed, in accordance with various embodiments. The operations shown in FIG. 2 and presented below are intended to be illustrative.

In some embodiments, the system 102 may obtain data 202 (e.g., training data) from the data store 108 and/or the computing device 109. The obtained data 202 may be stored in the memory 106. The system 102 may train a model or algorithm with the obtained data 202 to customize information feed. According to the customization, the system 102 may feed tailored information to computing devices.

In one example, the computing device 111 may transmit a query 204 to the system 102. The computing device 111 may be associated with an APP user. For example, when the user opens the APP, opens an interface of the APP, or otherwise triggers a rendering function of the APP, the query 204 may comprise a request for rendering in-application booth information. In response to the query 204, the system 102 may obtain the rendering data 207 according to the trained model and send the data 207 to the computing device 111. The data 207 may be displayed, played, or otherwise rendered on the computing device 111. Different users may receive customized information feed (data 207) such as activities that are predicted to optimize metrics like CTR.

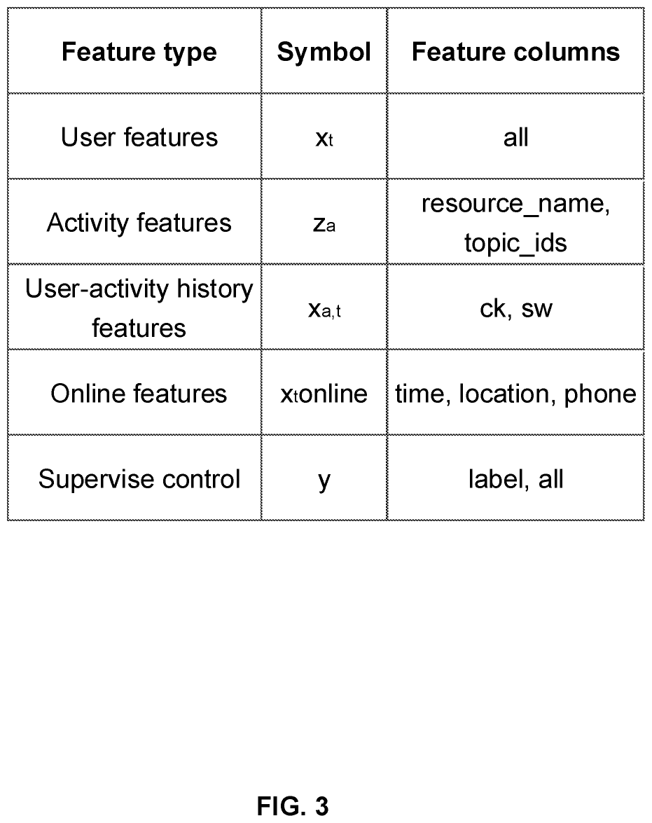

In some embodiments, each activity (a) may be a unit comprising various data points. The data points may be used as model inputs to train the disclosed model. The data points may comprise the click history of users (each user being t) who received the activity and other information. The features of each data point within units may comprise user features (xₜ), activity features (zₐ), and user-activity history (x_{a,t}) as shown in FIG. 3. The user features (xₜ) may comprise information entered by users or inferred from available information. For example, the user features (xₜ) may comprise personal bio information of the user (e.g., age, gender, residence zip code, etc.), APP use history of the user (e.g., ride hiring history, work address, residence address, preference for coupon usage, etc.), inferred information (e.g., income level inferred from the preference over luxury or economic rides based on the APP use history, income level inferred from the commute routes, etc.), online features (xₜonline) (e.g., time when using the APP, location when using the APP, and type of mobile phone carrying the APP, etc.). The activity features (zₐ) in association with each activity may comprise the rendering position (resource_name) in the APP, the topic of the activity (topic_ids), some descriptions of the activity, etc. The topic of the activity may be, for example, activity goal/education, activity goal/brand marketing, user scenario/weekend, user scenario/peak hour, user scenario/airport pickup, promotion/discount, promotion/third party gift, activity content/weather, activity content/safety, activity content/safety, etc. The user-activity history (x_{a,t}) may comprise a rate (sw) of rendering the activity and a rate (ck) that the user clicks or otherwise responds to the rendered activity. The data point may be further associated with a supervise control (y) comprising all historical values of the above parameters and a historical CTR.

In some embodiments, a Bayesian Two Stage (BTS) model that at least mitigates the deficiencies of the current technologies is disclosed to perform the prediction. The disclosed model may have two stages. The first stage (also referred to as global model, baseline mode, or cold start baseline model) may comprise a Bayesian learning model trained by data of all units and features of units. The second stage (also referred to as EM iteration) may comprise a mixed effect model with the results of first stage as initial prior knowledge of the EM estimation algorithm. The second stage may extract more relations from the first stage. The features of each unit may be incorporated at the first stage for a better estimation and then used as an initial Bayesian prior knowledge for the second stage estimation.

In some embodiments with respect to the first stage, the global model may be trained using data from all actions, so the global model can be used for new actions without any historical data and can serve as inputs for the second stage. The first stage model may be:

r_{t,a}=f(xₜ,zₐ)=σ(xₜ×\hat{θ}×zₐ^{T}) First user response prediction

Where r_{t,a} represents the estimated CTR of user t on rendered activity a, xₜ∈R^{k} and represents user features (e.g., location of the user while using the APP, personal bio information of the user, APP use history of the user, etc.), zₐ∈R^{m} and represents action features (e.g., amount of discount, location of the promotion, etc.), \hat{θ}∈R^{k×m} and represents the parameter matrix, σ( )is the sigmoid function, and T represent transpose. Thus, the global model is a logistic regression with cross product features. For Bayesian logistic regression, it is assumed that \hat{θ}˜Gaussian [θₚᵣᵢₒᵣ,Hₚᵣᵢₒᵣ]. By using history data {Xₜ,Zₐ,Y} corresponding to {xₜ,zₐ, y} of various data points as training data, a posterior distribution of \hat{θ}˜Gaussian [θₚₒₛₜₑᵣᵢₒᵣ,Hₚₒₛₜₑᵣᵢₒᵣ] may be obtained.

In some embodiments with respect to the second stage, after observing some data of a new action (e.g., rendering a new activity), a model can be trained based on the historical data and the prior knowledge \hat{θ}˜Gaussian [θₚₒₛₜₑᵣᵢₒᵣ,Hₚₒₛₜₑᵣᵢₒᵣ] derived from the first stage. In particular, if there is insufficient historical data for the new activity, the second stage can initialized based on the prior knowledge \hat{θ}˜Gaussian [θₚₒₛₜₑᵣᵢₒᵣ,Hₚₒₛₜₑᵣᵢₒᵣ] to achieve better training results more efficiently. The second stage model may be:

r_{t,a}=gₐ(x_{t and a,t})=σ( [symbol] x_{t and a,t}^{T}) Second user response prediction

Where the prior of [symbol] ˜Gaussian [θ×zₐ^{T},zₐ⊗H⊗zₐ^{T}] of which θ corresponds to θₚₒₛₜₑᵣᵢₒᵣ and H corresponds to Hₚₒₛₜₑᵣᵢₒᵣ from the first stage, and x_{t and a,t} comprises the user features (xₜ) and the user-activity history (x_{a,t}). By using training data {X_{a and a,t}, Yₐ}, a posterior distribution of [symbol] ˜Gaussian [βₐ^{posterior}, Λₐ^{posterior}] may be obtained.

Thus, with θ and H from the first stage results, the second stage model can be initialized closer to the true values and adaptively improve to achieve an accurate prediction, especially when the activity is relatively uncommon. Further, after the second stage training, [symbol] will give βₐ^{posterior}, Λₐ^{posterior}, which can be fed back to the first stage model to adjust the [θₚₒₛₜₑᵣᵢₒᵣ, Hₚₒₛₜₑᵣᵢₒᵣ].

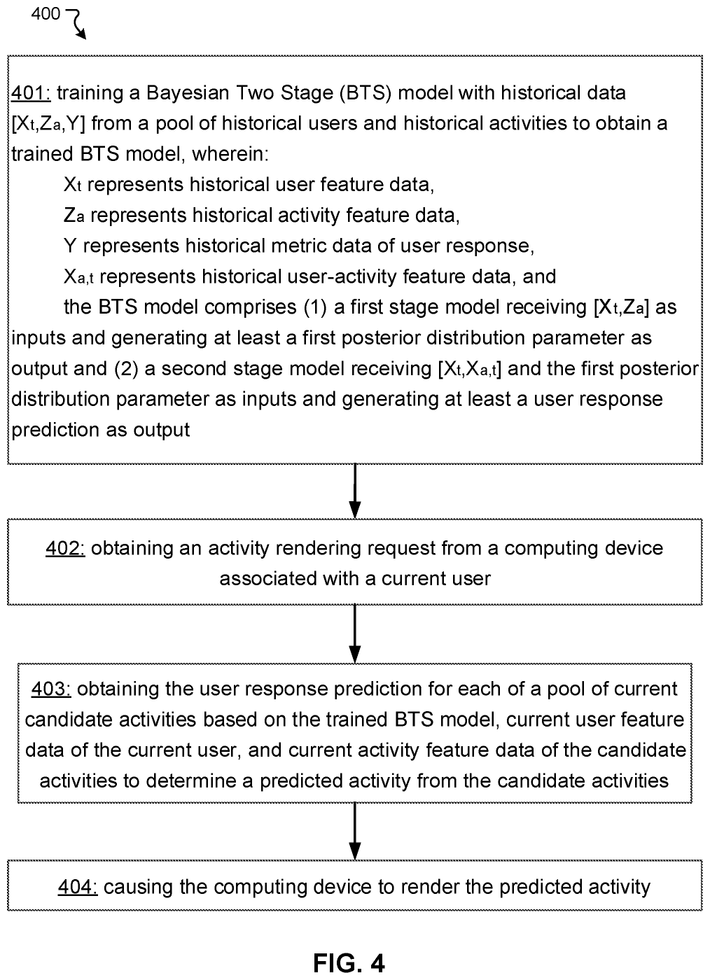

FIG. 4 illustrates a flowchart of an exemplary method 400 for customizing information feed, in accordance with various embodiments. The method 400 may be implemented, for example, by one or more components of the system 100 (e.g., the system 102). The exemplary method 400 may be implemented by multiple systems similar to the system 102. The operations of method 400 presented below are intended to be illustrative. Depending on the implementation, the exemplary method 400 may include additional, fewer, or alternative steps performed in various orders or in parallel.

Block 401 comprises training a Bayesian Two Stage (BTS) model with historical data [Xₜ,Zₐ,Y] from a pool of historical users and historical activities to obtain a trained BTS model, wherein: Xₜ represents historical user feature data, Zₐ represents historical activity feature data, Y represents historical metric data of user response, X_{a,t} represents historical user-activity feature data, and the BTS model comprises (1) a first stage model receiving [Xₜ,Zₐ] as inputs and generating at least a first posterior distribution parameter as output and (2) a second stage model receiving [Xₜ,X_{a,t}] and the first posterior distribution parameter as inputs and generating at least a user response prediction as output.

In some embodiments, the BTS model comprises (1) a first stage model receiving [Xₜ,Zₐ] as inputs and generating at least a first user response prediction and a first posterior distribution parameter as outputs and (2) a second stage model receiving [Xₜ,X_{a,t}] and the first posterior distribution parameter as inputs and generating at least a second user response prediction and a second posterior distribution parameter as outputs.

In some embodiments, the first stage model and the second stage model are Bayesian logistic regression models. In some embodiments, the second stage model further generates a second posterior distribution parameter as another output; and for the training, the second stage model feeds back the second posterior distribution parameter to the first stage model to adjust the first posterior distribution.

In some embodiments, for both the historical activity/user and the current activity/user, the user feature comprises personal bio information, Application (APP) use history, inferred information, and online features; the personal bio information comprises at least one of: age, gender, or residence zip code; the APP use history comprises at least one of: ride hiring history, work address, residence address, or preference for coupon usage; the inferred information comprises at least one of: income level or personal preference; and the online features comprise at least one of: time when using the APP, location when using the APP, or type of mobile phone carrying the APP. In some embodiments, the activity feature comprises a rendering position in an Application (APP) and a topic of the activity. In some embodiments, the user-activity feature comprises a rate rendering the activity in history and a rate receiving response to the rendered activity in history.

In some embodiments, the metric data of user response comprises a click through rate (CTR).

In some embodiments, the activity comprises: rendering coupon, rendering promotion, rendering reminder, rendering task, rendering advertisement, etc.

Block 402 comprises obtaining an activity rendering request from a computing device associated with a current user. For example, a user opening the APP or an interface of the APP may trigger a request for rendering to send to a server.

Block 403 comprises obtaining the user response prediction (e.g., the second user response prediction) for each of a pool of current candidate activities based on the trained BTS model, current user feature data of the current user, and current activity feature data of the candidate activities to determine a predicted activity from the candidate activities. In some situations requiring a fast response, the first user response prediction may be used in place of the second user response prediction.

In some embodiments, to optimize the CTR for model training, the response for user t toward the fed activity a may be determined as the estimated click probability r_{t,a}. For example, the response r_{t,a} and its confidence interval are computed for each candidate activity a in candidate actions A.

In some embodiments, the predicted activity has the best second user response prediction with respect to the metric data of user response (e.g., highest predicted CTR). In some embodiments, the predicted activity is determined based on an exploration algorithm with respect to the metric data of user response (e.g., second highest predicted CTR). That is, the best candidate activity may have the highest r_{t,a} or meet another condition according to an exploration algorithm. The exploration algorithm may provide a chance of rendering second best, third best, or another candidate to prevent the situation that only the best candidate is repeatedly rendered based on the feedback loop of the two stage model. The best candidate activity may be chosen to render in the APP.

Block 404 comprises causing the computing device to render the predicted activity. In some embodiments, the predicted activity may be associated with a display position, and causing the computing device to render the predicted activity may comprise causing the computing device to render the predicted activity at the display position.

Accordingly, the disclosed BTS model can achieve a robust and significant increase of 0.02 in AUC (area-under-the-receiver-operating-characteristic-curve) score against the state of art models. The disclosed model achieves a better generalization by incorporate features of units, a better utilization of uniqueness of each unit, and a better utilization of correlations among units. Further, since the disclosed model is within Bayesian framework, it can handle units with sufficient (e.g., by the first stage model) and sparse data (e.g., by the second stage model) all together without extra cold start step and is free of overfitting.

The disclosed BTS model improves the performance of computers at least in terms of customizing information feed. First, the BTS model can handle cold start activities and adaptively improve as more data is generated. In practice, each activity has a certain life time, so that the pool of activities is constantly changing every day. Recently added unit may start from zero data point. The BTS model can handle this cold start problem by first borrowing the information from other old activities which already have sufficient data and then adaptively evolving as more data come in for this activity. Also, the BTS model can make explorations to find the optimized solution to the contextual bandit problem because of its Bayesian nature which can naturally give confidence intervals of its predictions. Second, the BTS model can utilize both activity features and user-activity features. The first stage regression can incorporate activity features zₐ and utilize data of all activities to compute a Bayesian prior for each activity's second stage model. Based on the first stage results, the second stage model can utilize user-activity features and adaptively improve as more data is generated for that activity. Thus, overall, the BTS model can provide better predictions for determining the most effective information feed in an efficient manner.

The techniques described herein are implemented by one or more special-purpose computing devices. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

FIG. 5 is a block diagram that illustrates a computer system 500 upon which any of the embodiments described herein may be implemented. The system 500 may correspond to the system 102 or 103 described above. The computer system 500 includes a bus 502 or other communication mechanism for communicating information, one or more hardware processors 504 coupled with bus 502 for processing information. Hardware processor(s) 504 may be, for example, one or more general purpose microprocessors. The processor(s) 504 may correspond to the processor 104 described above.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions. The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions. The main memory 506, the ROM 508, and/or the storage 510 may correspond to the memory 106 described above.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the operations, methods, and processes described herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The main memory 506, the ROM 508, and/or the storage 510 may include non-transitory storage media. The term “non-transitory media,” and similar terms, as used herein refers to a media that store data and/or instructions that cause a machine to operate in a specific fashion, the media excludes transitory signals. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 500 also includes a network interface 518 coupled to bus 502. Network interface 518 provides a two-way data communication coupling to one or more network links that are connected to one or more local networks. For example, network interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic or optical signals that carry digital data streams representing various types of information. The network interface 518 may correspond to the network port 105 described above.

The computer system 500 can send messages and receive data, including program code, through the network(s), network link and network interface 518. In the Internet example, a server might transmit a requested code for an application program through the Internet, the ISP, the local network and the network interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some exemplary embodiments, the processors or processor-implemented engines may be located in a single geographic location (e.g., within a home environment, an office environment, or a server farm). In other exemplary embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A computer-implemented method for customizing information feed, comprising:
training a Bayesian Two Stage (BTS) model with historical data [Xₜ,Zₐ,Y] from a pool of historical users and historical activities to obtain a trained BTS model, wherein:
Xₜ represents historical user feature data,
Zₐ represents historical activity feature data,
Y represents historical metric data of user response,
X_{a,t} represents historical user-activity feature data, and
the BTS model comprises (1) a first stage model receiving [Xₜ,Zₐ] as inputs and generating at least a first posterior distribution parameter as output and (2) a second stage model receiving [Xₜ,X_{a,t}] and the first posterior distribution parameter as inputs and generating at least a user response prediction as output;
obtaining an activity rendering request from a computing device associated with a current user;
obtaining the user response prediction for each of a pool of current candidate activities based on the trained BTS model, current user feature data of the current user, and current activity feature data of the candidate activities to determine a predicted activity from the candidate activities; and
causing the computing device to render the predicted activity.

2. The method of claim 1, wherein:
the user feature comprises personal bio information, Application (APP) use history, inferred information, and online features;
the personal bio information comprises at least one of: age, gender, or residence zip code;
the APP use history comprises at least one of: ride hiring history, work address, residence address, or preference for coupon usage;
the inferred information comprises at least one of: income level or personal preference; and
the online features comprise at least one of: time when using the APP, location when using the APP, or type of mobile phone carrying the APP.

3. The method of claim 1, wherein: the activity feature comprises a rendering position in an Application (APP) and a topic of the activity.

4. The method of claim 1, wherein the user-activity feature comprises a rate rendering the activity in history and a rate receiving response to the rendered activity in history.

5. The method of claim 1, wherein the metric data of user response comprises a click through rate (CTR).

6. The method of claim 1, wherein: the activity is selected from a group consisting of: rendering coupon, rendering promotion, rendering reminder, rendering task, and rendering advertisement.

7. The method of claim 1, wherein:
the first stage model and the second stage model are Bayesian logistic regression models;
the second stage model further generates a second posterior distribution parameter as another output; and
for the training, the second stage model feeds back the second posterior distribution parameter to the first stage model to adjust the first posterior distribution.

8. The method of claim 1, wherein the predicted activity has the best second user response prediction with respect to the metric data of user response.

9. The method of claim 1, wherein the predicted activity is determined based on an exploration algorithm with respect to the metric data of user response.

10. A system for customizing information feed, comprising: a processor and a non-transitory computer-readable storage medium storing instructions that, when executed by the processor, cause the system to perform:
training a Bayesian Two Stage (BTS) model with historical data [Xₜ,Zₐ,Y] from a pool of historical users and historical activities to obtain a trained BTS model, wherein:
Xₜ represents historical user feature data,
Zₐ represents historical activity feature data,
Y represents historical metric data of user response,
Xₐ,ₜ represents historical user-activity feature data, and
the BTS model comprises (1) a first stage model receiving [Xₜ,Zₐ] as inputs and generating at least a first posterior distribution parameter as output and (2) a second stage model receiving [Xₜ,X_{a,t}] and the first posterior distribution parameter as inputs and generating at least a user response prediction as output;
obtaining an activity rendering request from a computing device associated with a current user;
obtaining the user response prediction for each of a pool of current candidate activities based on the trained BTS model, current user feature data of the current user, and current activity feature data of the candidate activities to determine a predicted activity from the candidate activities; and
causing the computing device to render the predicted activity.

11. The system of claim 10, wherein:
the user feature comprises personal bio information, Application (APP) use history, inferred information, and online features;
the personal bio information comprises at least one of: age, gender, or residence zip code;
the APP use history comprises at least one of: ride hiring history, work address, residence address, or preference for coupon usage;
the inferred information comprises at least one of: income level or personal preference; and
the online features comprise at least one of: time when using the APP, location when using the APP, or type of mobile phone carrying the APP.

12. The system of claim 10, wherein: the activity feature comprises a rendering position in an Application (APP) and a topic of the activity.

13. The system of claim 10, wherein the user-activity feature comprises a rate rendering the activity in history and a rate receiving response to the rendered activity in history.

14. The system of claim 10, wherein the metric data of user response comprises a click through rate (CTR).

15. The system of claim 10, wherein: the activity is selected from a group consisting of: rendering coupon, rendering promotion, rendering reminder, rendering task, and rendering advertisement.

16. The system of claim 10, wherein:
the first stage model and the second stage model are Bayesian logistic regression models;
the second stage model further generates a second posterior distribution parameter as another output; and
for the training, the second stage model feeds back the second posterior distribution parameter to the first stage model to adjust the first posterior distribution.

17. The system of claim 10, wherein the predicted activity has the best second user response prediction with respect to the metric data of user response.

18. The system of claim 10, wherein the predicted activity is determined based on an exploration algorithm with respect to the metric data of user response.

19. A non-transitory computer-readable storage medium storing instructions that, when executed by a processor, cause the processor to perform:
training a Bayesian Two Stage (BTS) model with historical data [Xₜ,Zₐ,Y] from a pool of historical users and historical activities to obtain a trained BTS model, wherein:
Xₜ represents historical user feature data,
Zₐ represents historical activity feature data,
Y represents historical metric data of user response,
Xₐ,ₜ represents historical user-activity feature data, and
the BTS model comprises (1) a first stage model receiving [Xₜ,Zₐ] as inputs and generating at least a first posterior distribution parameter as output and (2) a second stage model receiving [Xₜ,X_{a,t}] and the first posterior distribution parameter as inputs and generating at least a user response prediction as output;
obtaining an activity rendering request from a computing device associated with a current user;
obtaining the user response prediction for each of a pool of current candidate activities based on the trained BTS model, current user feature data of the current user, and current activity feature data of the candidate activities to determine a predicted activity from the candidate activities; and
causing the computing device to render the predicted activity.

20. The storage medium of claim 19, wherein:
the first stage model and the second stage model are Bayesian logistic regression models;
the second stage model further generates a second posterior distribution parameter as another output; and
for the training, the second stage model feeds back the second posterior distribution parameter to the first stage model to adjust the first posterior distribution.
